(19) United States
(12) Patent Application Publication
(10) Pub. No.: US 2013/0208444 A1
(43) Pub. Date: Aug. 15, 2013

(54) Rechargeable Self-Illuminating Sticks And Charging Devices For Charging The Same

(71) Applicant: Zachary Green, Cincinnati, OH (US)

(72) Inventor: Zachary Green, Cincinnati, OH (US)

(21) Appl. No.: 13/766,852

(22) Filed: Feb. 14, 2013

Related U.S. Application Data
(60) Provisional application No. 61/598,532, filed on Feb. 14, 2012.

(51) Int. Cl. F21L 27/00

(52) U.S. Cl. CPC F21L 27/00
USPC 362/84

(57) ABSTRACT

A self-illuminating stick includes a phosphor embedded in a solidified polymeric binder. The phosphor can absorb energy to emit electromagnetic radiation having one or more of an ultraviolet wavelength, a visible light wavelength, and an infrared wavelength. A charging device for enclosing a self-illuminating stick and providing the self-illuminating stick with electromagnetic radiation to charge the phosphor is disclosed.

### CROSS REFERENCE TO RELATED APPLICATIONS

This application claims the benefit of U.S. Provisional Patent Application Ser. No. 61/598,532, filed Feb. 14, 2012, and titled “Rechargeable Self-Illuminating Sticks and Charging Devices for Charging the Same.”

### BACKGROUND

Environments having low visible light often lead to low visibility conditions. The low visibility conditions may decrease mobility of individuals attempting to leave the environment or individuals, for example firefighters, who must perform tasks in the environment. Moreover, identification of such individuals in low visibility conditions may be impaired even when reflective materials are used as the lack of visible light renders the reflectors inoperable.

Methods of illuminating such environments typically include electrical lights. However, such electrical lights require a power source. Both the electrical light and the power source are prone to failure in adverse environmental conditions. When such power sources fail, reflective materials are rendered ineffective.

Further, in certain environments, it may be desirable to emit electromagnetic radiation at wavelengths that are not visible to human sight. In such environments, for example, in end-user applications for defense operators, it may be beneficial to emit electromagnetic radiation that is visible through night-vision goggles, and therefore visible to those so-equipped with the appropriate equipment, but invisible to those not equipped with the appropriate equipment. Accordingly, self-illuminating sticks that provide light without a power source, along with charging devices for charging the self-illuminating sticks, are desired.

### SUMMARY

A self-illuminating stick includes a phosphor embedded in a solidified polymeric binder. The phosphor can absorb energy to emit electromagnetic radiation having one or more of an ultraviolet wavelength, a visible light wavelength, and an infrared wavelength. A charging device for enclosing a self-illuminating stick and providing the self-illuminating stick with electromagnetic radiation to charge the phosphor is disclosed.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a self-illuminating stick according to one or more embodiment shown and described herein;

FIG. 2 schematically depicts a sectional view of a self-illuminating stick shown along line A-A of FIG. 1;

FIG. 3 schematically depicts a sectional view of a self-illuminating stick according to one or more embodiments shown and described herein;

FIG. 4 schematically depicts an exploded perspective view of a self-illuminating stick according to one or more embodiment shown and described herein and a charging device for charging the self-illuminating stick according to one or more embodiments shown and described herein;

FIG. 5 schematically depicts sectional side view of the self-illuminating stick and the charging device shown along line B-B of FIG. 4; and

FIG. 6 schematically depicts a perspective side view of a charging device according to one or more embodiments shown and described herein.

### DETAILED DESCRIPTION

Embodiments described herein relate to a self-illuminating stick that includes a phosphor embedded in a solidified polymeric binder. The phosphor can absorb energy to emit electromagnetic radiation having one or more of an ultraviolet wavelength, a visible light wavelength, and an infrared wavelength. A charging device for enclosing a self-illuminating stick and providing the self-illuminating stick with electromagnetic radiation to charge the phosphor is disclosed. The self-illuminating sticks and the charging device for charging the same will be described in more detail herein with specific reference to the appended drawings.

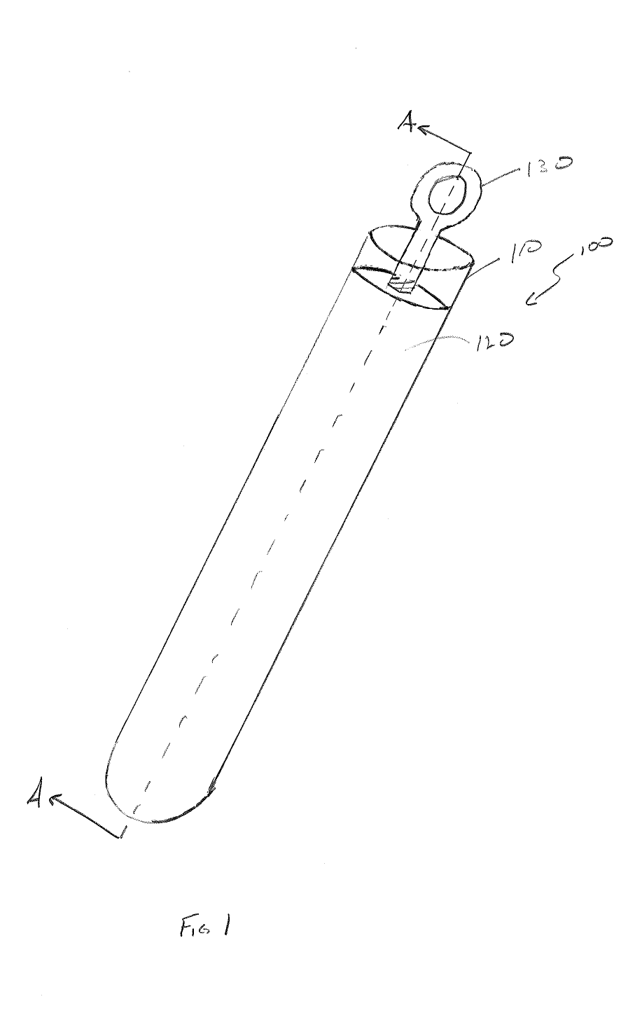

Referring to FIG. 1, a self-illuminating stick 100 is depicted. The self-illuminating stick 100 includes an emitting component 120 having a phosphorescent material embedded in a carrier, such that the emitting component 120 is rigid and resilient. The emitting component 120 may include a variety of phosphorescent materials that are capable of absorbing energy transmitted from a light source, storing the energy, and emitting the energy by excitation of the phosphorescent material over a long duration of time after which the light source is removed. Examples of such phosphorescent material include strontium aluminate, which emits visible light at about 490 nanometers (blue) and about 505 nanometers (blue-green). Other wavelengths of light may be produced by introducing a colored pigment to the emitting component 120 along with the strontium aluminate. The strontium aluminate will continue to emit electromagnetic radiation at the above-referenced wavelengths, and will also excite the pigment to illuminate at the appropriate wavelength. Another example of such phosphorescent material is Cr^{3±}-doped zinc gallogermanate NIR persistent phosphor, as described in “Sunlight-activated long-persistent luminescence in the near-infrared from Cr3+-doped zinc gallogermanates” by Zhengwei Pan, Yi-Ying Lu, Feng Liu in Nature Materials 11, 58-63 (2012), the entire disclosure of which is incorporated herein by reference. Such zinc-based phosphors may exhibit emission having wavelengths from about 650 nanometers to about 1000 nanometers, generally in the near-infrared range of electromagnetic radiation. In addition, other phosphors may exhibit emissions having wavelengths less than about 400 nanometers, for example less than about 380 nanometers, generally in the near-ultraviolet range of electromagnetic radiation. Still other phosphors may exhibit emissions having wavelengths greater than about 650 nanometers and less than about 400 nanometers, with no or a small amount of emissions having wavelengths from about 400 nanometers to about 650 nanometers. Some emitting components 120 may include a first phosphor that exhibits emission having wavelengths greater than about 650 and a second phosphor that exhibits emissions having wavelengths less than about 400 nanometers.

The phosphors may be mixed with liquid polymers that are hardened to form the emitting components 120. Example of such liquid polymers include epoxy, polyester, polyamide, polystyrene, or any other thermoplastic or thermosetting resins that allow the transmission of electromagnetic radiation by the phosphors and provide the required mechanical properties. The phosphors may be introduced to the polymer at a ratio from about 1:100 phosphor to polymer to about 2:1 phosphor to polymer, by weight, for example from about 1:100 phosphor to polymer to about 1:1 phosphor to polymer. For polymers that are polymerized or cross-linked using a hardener, a polymerization agent, or a cross-linking agent, the phosphor may be added to both the raw polymer and the hardener, for example, such that the resulting emitting components 120 includes a relatively large quantity of phosphor.

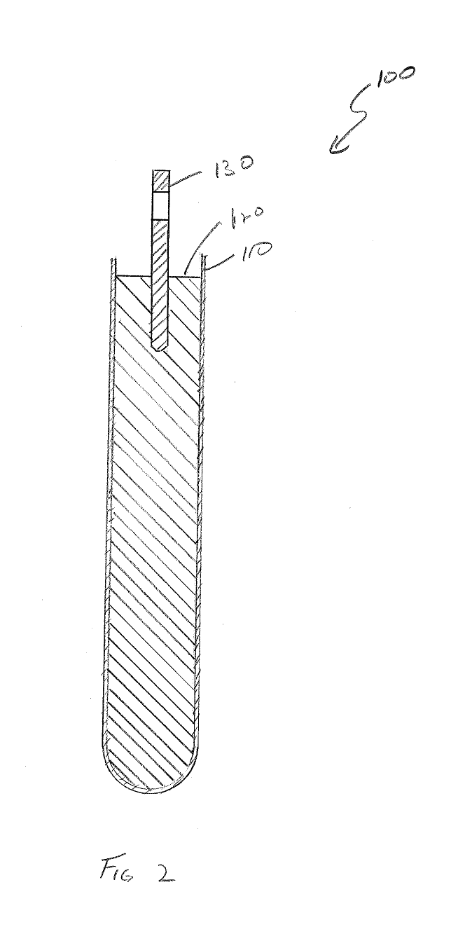

Referring to FIGS. 1 and 2, the emitting component 120 may be introduced to a shell 110 while the emitting component 120 is in a fluid state, for example, before the hardener has time to cure the epoxy resin. The fluid emitting component 120 flow throughout the internal cavity of the shell 110, where it collects by pooling and cures, forming a solidified emitting component 120. During the time in which the emitting component 120 is curing, an eyelet 130 may be inserted into the fluid emitting component 120. Alternatively, or in addition, the emitting component 120 may be machined after the curing is complete. The eyelet 130 may be secured within the emitting component 120, for example, by machining threads into the emitting component 120 into which corresponding threads of the eyelet 130 can be inserted.

The shell 110 may be a material suitable for allowing transmission of electromagnetic radiation from the emitting component 120 to the environment. Such materials may include, without limitation, polycarbonate, tempered glass, and soda-lime glass.

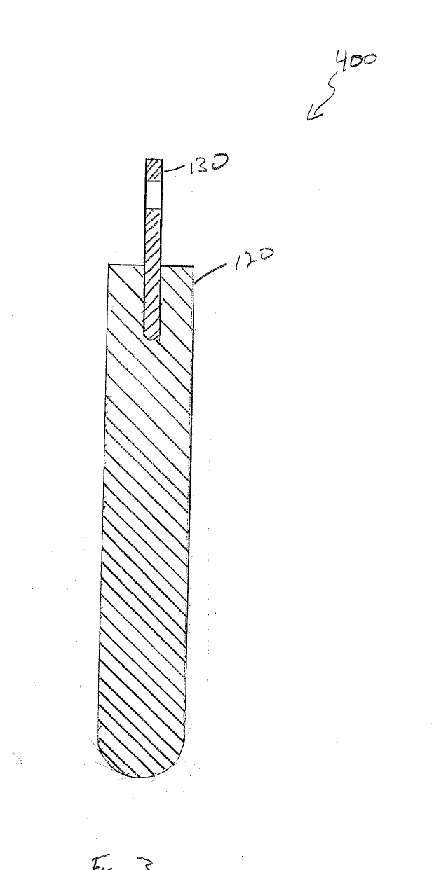

Referring now to FIG. 3, another embodiment of the self-illuminating stick 400 is depicted. In this embodiment, the emitting component 120 is depicted excluding any external shell. Such an emitting component 120 may produced from a liquid polymer that is introduced to a female mold, for example, a two-part aluminum mold having a cavity corresponding to the shape of the solidified emitting component 120. The two-part aluminum mold may be separated to ease removal of the emitting component 120 after curing.

The self-illuminating sticks 100, 400 may be capable of being recharged when exposed to natural sunlight or artificial light. For example, exposure to a light having at least 1 Candlepower may be sufficient to charge the emitting component 120 of the self-illuminating sticks 100, 400. Further, it has been observed that for some phosphor components, the emitting components 120 charge with a higher efficiency when exposed to artificial light having a wavelength in the ultraviolet range (i.e., wavelengths less than about 400 nanometers) than when exposed to artificial light having wavelengths in the visible light range (i.e., from about 380 nanometers to about 750 nanometers).

It has been observed that the amount of energy stored by the phosphor component, or the “charge” of the emitting component 120, may allow the emitting component 120 to emit electromagnetic radiation for a time period after a light source has been extinguished. Such emitting components 120 have been shown to emit electromagnetic radiation for greater than about 10 hours. Further, for the same samples, it was determined that the emitting components 120 reached “full charge” after about 5 minutes of exposure to a light source. Restated, additional charging time beyond about 5 minutes did not increase the duration of electromagnetic radiation of the emitting components 120 after the light source was extinguished.

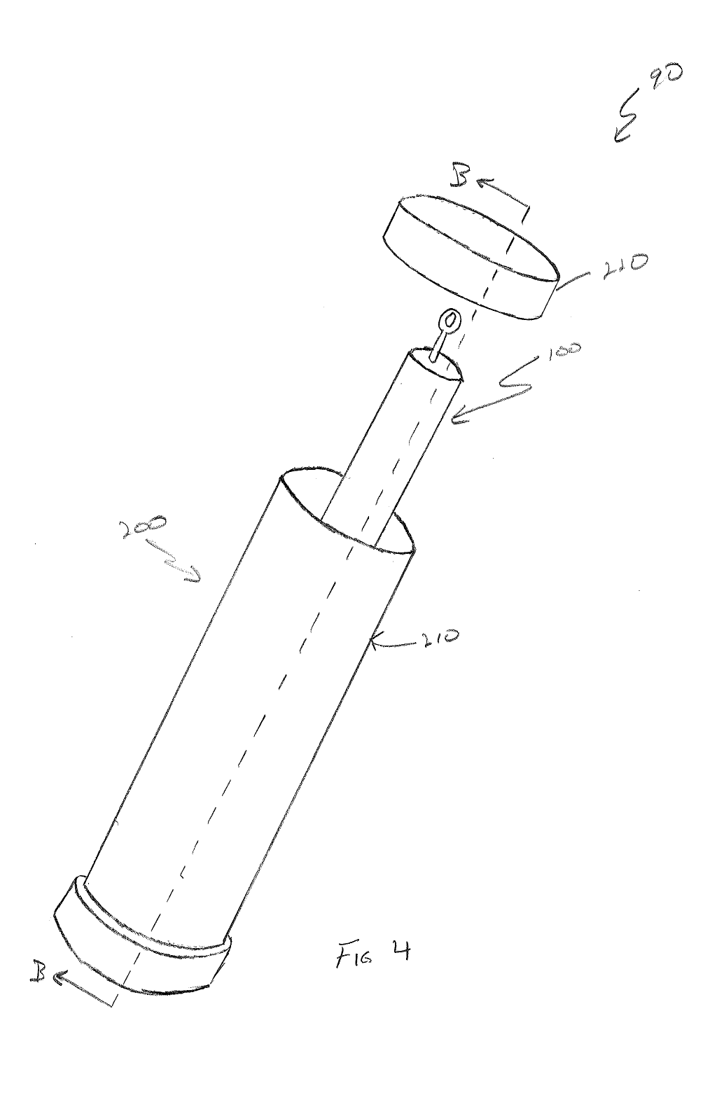

Referring now to FIG. 4, a charging device 200 for exposing the self-illuminating stick 100 to a light source is depicted. The charging device 200 includes an elongate body 210 and a cap 220 that is removed and detached from one end of the elongate body 210. The self-illuminating stick 100 and the charging device 200 together form the illumination system 90. Because the charging device 200 is approximately the same size as the self-illuminating stick 100, the illumination system 90 is portable and may be carried without significant burden by a person.

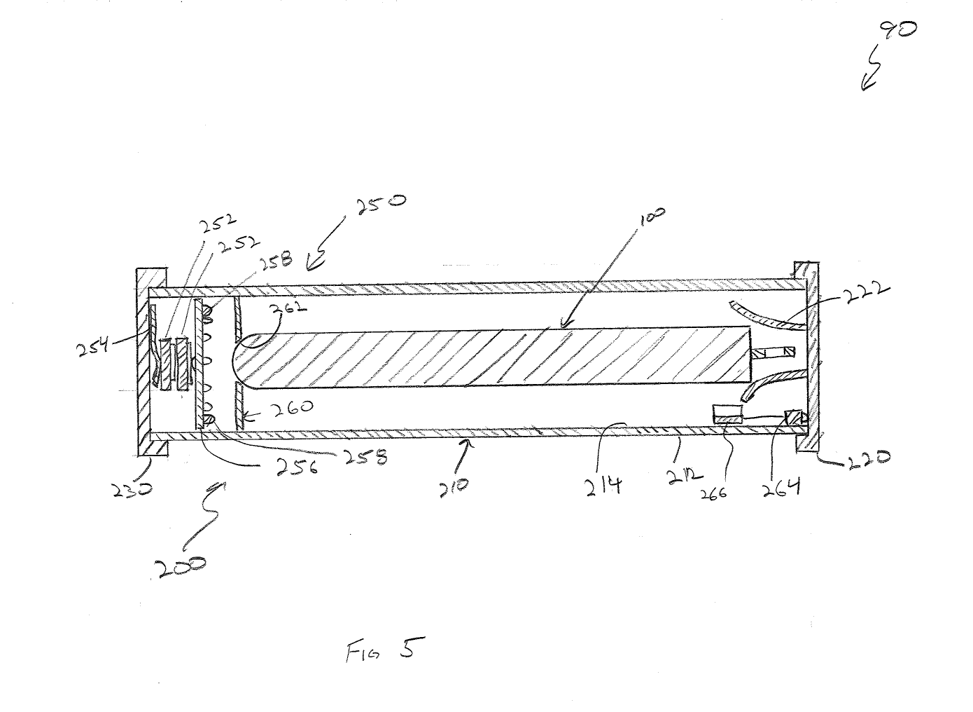

Referring now to FIG. 5, the charging device 200 and the self-illuminating stick 100 are depicted with the self-illuminating stick 100 positioned in a “charging” position within the charging device 200, and the cap 220 installed onto the elongate body 210. The charging device 200 further includes an enclosure cap 230 positioned along the elongate body 210 opposite the cap 220. The elongate body 210 includes an outer shell 212 that forms a generally rigid member that provides the charging device 200 with structure. An interior surface 214 of the outer shell 212 includes a reflective surface that reflects electromagnetic radiation inside the elongate body 210 of the charging device 200, minimizing the absorption of electromagnetic radiation by the outer shell 212. In some embodiments, the elongate body 210 may be made from steel or aluminum or alloys thereof. The interior surface 214 of such elongate bodies 210 may be polished to a high shine to reflect electromagnetic radiation within the elongate body. In other embodiments, the elongate body 210 may be made from a composite material, for example, a fiberglass or carbon fiber-reinforced polymer. In such embodiments, the interior surface 214 of the elongate bodies 210 may include a laminate layer that is applied to the interior surface 214 to increase the reflectivity of the composite material. In one embodiment, the laminate layer applied to the interior surface 214 may include a metalized Mylar® film that provides the interior surface 214 with a reflective surface.

The charging device 200 may also include first and second spacers 260, 222 that retain the self-illuminating stick 100 in an appropriate position relative to the interior surface 214 of the elongate body 210. As depicted, the first spacer 260 may include a locating feature 262, for example a through hole with or without a countersink, that allows a contoured end of the self-illuminating stick 100 to self-center itself within the elongate body 210. The second spacer 222 may extend from one or more of the elongate body 210 and the cap 220, and include lead-in features such as a chamfer or a round that contacts the self-illuminating stick 100 to self-center the self-illuminating stick 100 within the elongate body 210. The first and the second spacers 260, 222 may be made from a variety of materials, including materials that allow transmission of electromagnetic radiation.

The charging device 200 also includes a charging system 250 that is electrically powered. The charging system 250 includes at least one battery cell 252 configured to provide electricity to a light source 256. As depicted, the light source 256 includes a plurality of light emitting diodes 258 that are arranged along a circuit board, however, alternate embodiments of the light source 256 are contemplated. The light emitting diodes 258 may be configured to produce electromagnetic radiation in a variety of wavelengths, including ultraviolet wavelengths, visible light wavelengths, and infrared wavelengths. The battery cells 252 are electrically coupled to the light source 256 with a terminal 254. As depicted, the terminal 254 may be positioned proximate to the enclosure cap 230 to facilitate replacement of the battery cells 252 upon discharge.

The charging system 250 may also include a switch 264 electrically coupled to the battery cells 252 and the light source 256. The switch 264 may be functional to allow the battery cells 252 to energize the light source 256 when the cap 220 is secured to the elongate body 210, and de-energize the light source 256 when the cap 220 is removed from the elongate body 210. The charging system 250 may further include a computerized controller 266 having a processor and a memory for storing software that includes computer readable instructions. When triggered to run, for example by the switch 264, the processor executes the computer readable instructions to control operation of the light source 256. The computerized controller 266 may control operation of the light source 256, for example by limiting the time of operation of the light source 256 to a pre-determined maximum value, such as about 5 minutes. By limiting operation of the light source 256, the battery cells 252 may operate for a longer time before being discharged, necessitating replacement.

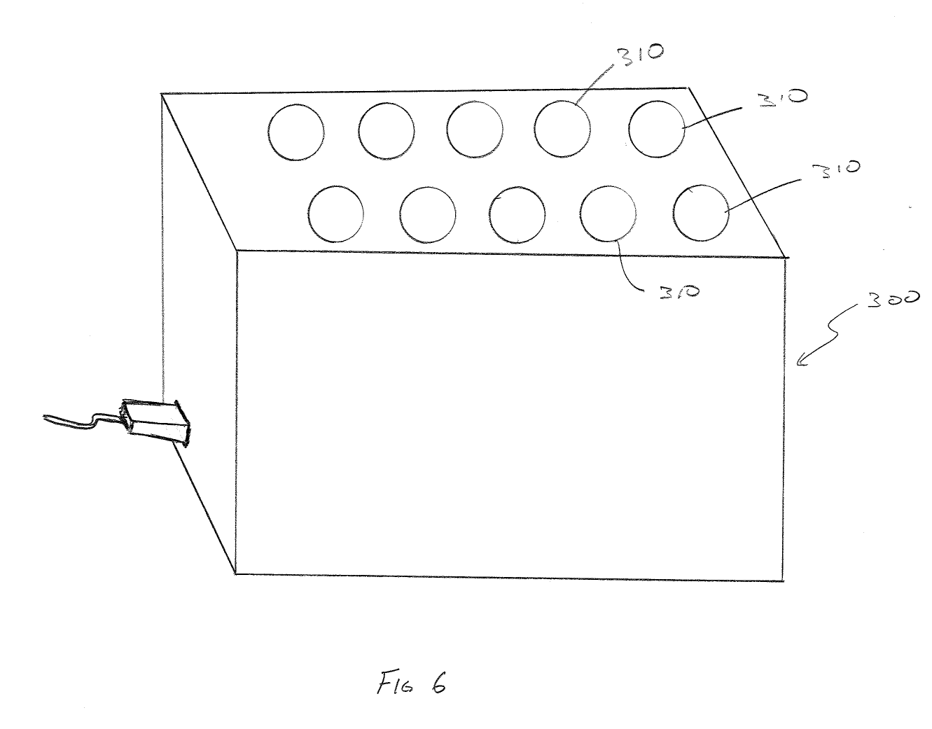

Referring now to FIG. 6, a stationary charging device 300 is depicted. The stationary charging device 300 includes a plurality of openings 310 to accept self-illuminating sticks 100 (not shown). Each of the openings 310 of the stationary charging device 300 may include a charging system 250 similar to that shown in FIG. 5 above, including a light source 256 positioned along one end of the opening 310. Power may be provided to the light source 256 through mains power. The stationary charging device 300 may allow for multiple self-illuminating sticks 100 to be charge simultaneously.

It should now be understood that self-illuminating sticks according to the present disclosure allow for the generation of electromagnetic radiation in wavelengths corresponding to the visible light range as well as the infrared and ultraviolet ranges. The self-illuminating sticks are charged when exposed to natural or artificial electromagnetic radiation, including visible light. Charging devices that expose the self-illuminating sticks to electromagnetic radiation are disclosed. The charging devices provide electromagnetic radiation having a wavelength that charges the self-illuminating sticks. The self-illuminating sticks and the charging devices are portable for use in a variety of environments.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. An illumination system kit comprising:
a self-illuminating stick comprising an emitting component solidified within a shell; and
a charging device comprising at least one opening and a plurality of light emitting diodes positioned within the opening,
wherein when the self-illuminating stick is inserted within the opening, the light emitting diodes are selected to illuminate, thereby charging the emitting component of the self-illuminating stick.
